(19) United States
(12) Patent Application Publication
(10) Pub. No.: US 2005/0045271 A1
(43) Pub. Date: Mar. 3, 2005

(54) Method of producing reinforced cartons

(76) Inventor: Robert J. Hunter, Woodstock, GA (US)

Correspondence Address: Steve M. McLary;Graphic Packaging International, Inc., 814 Livingston Court, Marietta, GA, 30067, US

(21) Appl. No.: 10/651,431

(22) Filed: Aug. 30, 2003

(51) Int. Cl. B32B 1/00; B32B 31/00

(52) U.S. Cl. 156/257; 156/166; 156/517; 156/522; 156/259; 156/265

(57) ABSTRACT

A process for forming reinforced cartons in which one or more reinforcing strips are laminated to a carton material along a processing line or path. As the reinforcing strips and carton material are fed along the processing path, cold set and hot melt adhesive materials are applied to resist de-lamination of the reinforcing strips and carton material during downstream cutting operations.

### FIELD OF THE INVENTION

The present invention generally relates to the manufacture of cartons, and in particular, to a method of forming a reinforced carton blank having at least one strip of reinforcing material laminated to a paperboard carton material.

### BACKGROUND OF THE INVENTION

Currently, the lamination of paperboard carton materials together for forming carton blanks generally is done in a roll to roll process using a cold set glue, wherein the cold set glue is rolled, sprayed or otherwise applied to a web of paperboard material, over which an additional web or strips of material are applied. The laminated material is then wound about a roll, after which the roll of laminated material is stored to allow the cold set glue to cure, typically for at least several hours, before the laminated material can be transferred to a cutting line for die cutting carton blanks from the laminated carton material. Cold set glues or adhesive materials typically are used due to their low cost and ability to provide significant high/low temperature bonding qualities. Such cold set adhesives typically do not degrade or breakdown when exposed to high heats (e.g., during transport or storage in a hot climates) and alternatively, when exposed to freezing temperatures, tend to maintain their adhesion and resist cracking and breaking during handling. However, given the relatively long cure times required for setting the cold set adhesive materials, production rates for the formation of laminated paperboard or carton materials using cold set adhesives generally are limited. It therefore typically is necessary to form the cartons in a multi-step process with a delay of several hours or more between the formation of such laminated paperboard carton material on a first production line, and the cutting of the carton blanks therefrom in a separate cutting operation, so that the cold set adhesive is allowed to sufficiently cure to prevent shifting or de-lamination of the carton materials during cutting.

Alternatively, hot melt adhesives have been used to laminate paperboard webs or sheets together to form laminated carton materials. In such processes, the hot melt adhesive or glue will be applied between the web materials, and typically will cure or set up in seconds. When the laminated sheet arrives at a downstream cutter, the sheets generally are already bonded together to enable cutting without shifting or de-lamination of the sheets. As a result, the carton materials can be laminated together and die cut along the same processing line resulting in increased production rates. However, the hot melt adhesives required for applying or laminating the cartons materials together generally are significantly more expensive than cold set adhesives and additionally do not tend to have as good a range of high and low temperature bonding properties as cold set adhesives. In contrast to most cold set adhesives, such hot melt adhesives typically can become degraded when exposed to higher temperatures or climates, while in more frigid climates, hot melt adhesives tend to become brittle and subject to cracking and breaking when temperatures drop as low as 0° F., which ultimately can result in the sheets of the carton material de-laminating or otherwise coming apart. Still further, hot melt adhesives applied along score lines at which the carton material is bent or folded tend to be more susceptible to cracking and failure.

Accordingly, it can be seen that a need exists for a process and system of forming laminated carton blanks that addresses the forgoing and other related problems in the art.

### SUMMARY OF THE INVENTION

Briefly described, the present invention is generally directed to a system and method for forming reinforced carton blanks in which strips of a reinforcing material are applied to a carton material along a processing line or path as part of a single, substantially continuous operation at enhanced production rates. Typically, the reinforcing material, which can include strips of paperboard, thermoplastics or other natural or synthetic reinforcing materials will be fed along a processing path from an upstream supply toward registration and engagement with a carton material such as a paperboard web or sheet material. The reinforcing material strips are initially passed through a cold set adhesive applicator that applies a measured amount of a cold set adhesive along a surface of the reinforcing strips. Thereafter, the reinforcing strips are passed through a hot melt adhesive station, at which a series of applicators apply beads or lines of a liquid hot melt adhesive along one or more of the peripheral side edges of the reinforcing material strips, and/or can apply an additional bead or line of hot melt adhesive along a centerline of each of the reinforcing material strips as needed.

After the hot melt adhesive has been applied to the reinforcing strips, the carton material is fed into engagement with the reinforcing material strips. The reinforcing material strips and carton material are then passed through a laminating station. The laminating station typically includes at least one pair of nip or compression rollers that compress or otherwise urge the reinforcing material strips and carton material into tight, adhesive contact. The hot melt adhesive causes the carton material and reinforcing material strips to be adhered to each other at the points or locations along which the hot melt adhesive has been applied, such as along the peripheral side edges of the reinforcing material strips and/or along a center portion thereof. The laminated carton material is then passed through a series of s-wraps or puller rolls that move the laminated carton material about approximately 180° turns as the hot melt adhesive is set or cured, to prevent de-lamination of the plies of the reinforcing material strips and carton material.

Thereafter, the carton material with the reinforcing material strips laminated thereto is passed into a cutting station for cutting the carton blanks therefrom. The adhesion of the reinforcing material strips to the carton material by the hot melt adhesive helps hold the strips in place and prevents de-lamination of the plies of material during cutting and formation of the carton blanks. The carton blanks can then be stacked and stored for shipment or later use, while the cold set adhesive material is permitted to cure, which results in superior bonding strength and properties when the cartons are later used for packaging various types of products.

Various objects, features and advantages of the present invention will become apparent to those skilled in the art upon reading the following specification when taken in conjunction with the accompanying drawings.

### BRIEF DESCRIPTION OF THE DRAWINGS

FIGS. 1A and 1B are perspective views schematically illustrating the process for forming reinforced carton blanks according to the present invention.

### DETAILED DESCRIPTION

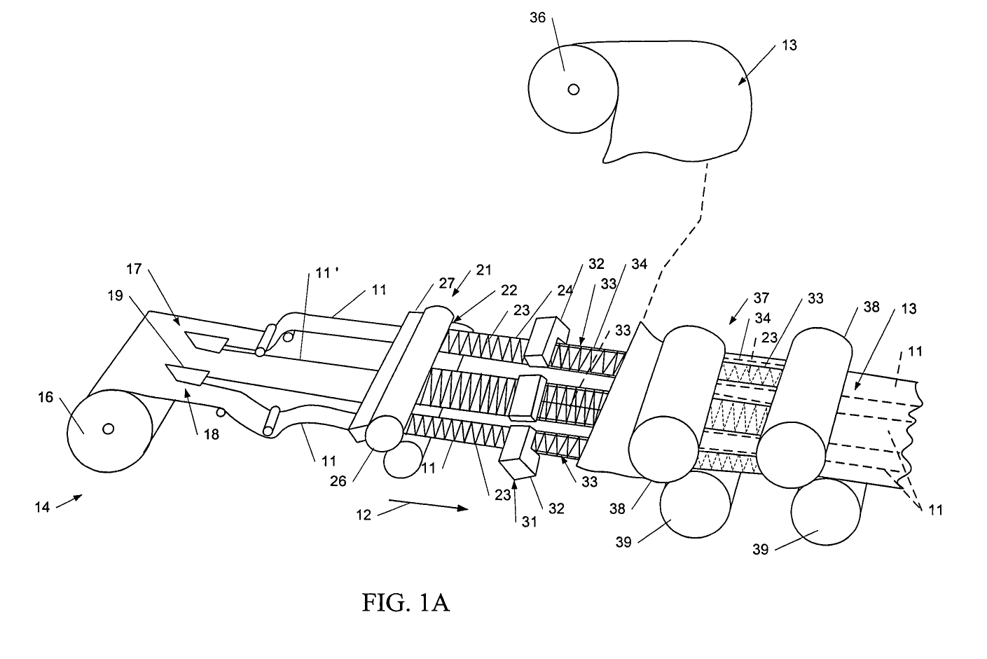

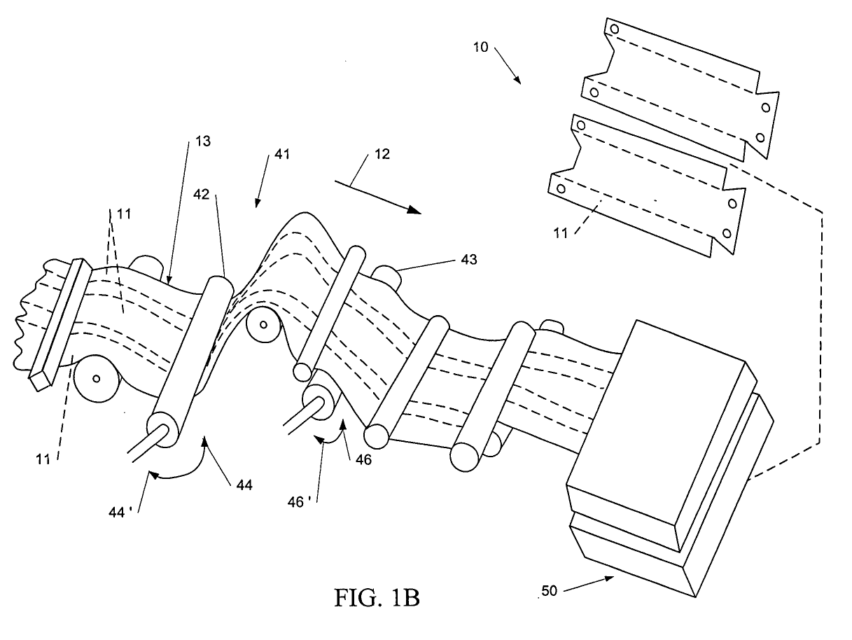

Referring now in greater detail to the drawings, in which like numerals indicate like parts throughout the views, FIGS. 1A and 1B schematically illustrate the process of the present invention for forming reinforced carton blanks 10, which process can be performed in a substantially continuous operation at production speeds of upwards of over approximately 100 feet per minute. As FIG. 1A indicates, a series of reinforcing material strips 11 generally will be fed along a processing line or path 12, into registration with a carton material 13 to form a laminated, reinforced carton material sheet from which the carton blanks 10 (FIG. 1B) thereafter will be formed.

The reinforcing strips 11 (FIG. 1A) generally are fed from a supply 14 and can be formed from paperboard or cardboard materials, but also can be formed from other types of reinforcing materials, including plastic and/or other synthetic or natural materials, as will be understood by those skilled in the art. As indicated in FIG. 1A, the supply of reinforcing material 14 for the reinforcing strips 11 can include an upstream supply roll 16 that feeds a sheet or web of the reinforcing material, as indicated at 17, through a cutting or slitting station 18. The cutting station typically will include one or more cutting blades 19 that engage and cut the sheet of reinforcing material to form a series or reinforcing strips 11. It will be understood by those skilled in the art that while the cutting or slitting station 18 is shown in FIG. 1A as including two cutting blades 19, more or fewer cutting blades can be used to form additional reinforcing strips or for cutting reinforcing strips of various widths or sizes as needed or desired. For example, the middle strip 11′ can be formed with an expanded width or size, depending on the orientation and number of carton blank repeats being formed from the laminated reinforced carton material sheet.

Still further, it will also be understood by those skilled in the art that the supply of reinforcing material 14 alternatively can include one or more smaller rolls of reinforcing material that are precut to a desired width as needed for forming the reinforcing strips. These precut strips can be fed directly from their supply roll without having to initially pass through a cutting station 18 to form the reinforcing strips.

As indicated in FIG. 1A, as the reinforcing strips are moved along their processing path 12, they are initially passed through a first adhesive station 21 that includes a cold set adhesive applicator 22 for applying a measured layer or film of a cold set adhesive material 23 along an upper facing edge or surface 24 of the reinforcing strips 11. The cold set adhesive applicator 22 is shown in FIG. 1 as including an applicator roll 26 that picks up the cold set adhesive 23 from a supply 27 and applies it to the upper surface 24 of the reinforcing strips. It will also be understood that other types of adhesive applicators such as spray guns, extrusion nozzles and various other, similar applicator systems also can be used for applying the cold set adhesive. The cold set adhesive material generally can include a polyvinyl acetate (PVA) adhesive that will be foamed (i.e., mixed with air) and rolled, extruded, sprayed or otherwise applied to the upper surfaces of the reinforcing strips. It will be understood that various other types of cold set adhesives, including starch based (i.e., corn starch) adhesives, ethylene vinyl acetate (EVA), dextrin adhesives, and other known cold set adhesives or materials and/or mixtures thereof as are typically used in the paperboard packaging industry, also can be used in the present invention.

After application of the cold set adhesive 23 to the reinforcing strips 11, the reinforcing strips are then passed through a second or downstream adhesive station 31, which generally includes one or more hot melt adhesive applicators 32. The hot melt adhesive applicator 32 can include spray nozzles, extruding heads or nozzles, rollers, or other known types of hot melt adhesive applicators and generally will apply a bead or line of a hot melt adhesive, as indicated by 33, along one or both of the peripheral side edges 34 of the reinforcing strips. Still further, as indicated in FIG. 1, a bead or line of hot melt adhesive 33 also can be applied substantially along a center portion or centerline of the adhesive strips as needed.

The hot melt adhesive applicators generally will apply a measured, limited amount of hot melt adhesive, which is sufficient to engage and hold the reinforcing strips against the carton material 13 as needed to prevent de-lamination of the reinforcing strips and carton material during the downstream cutting operation. The hot melt adhesive generally will include an ethylene vinyl acetate (EVA) adhesive that typically will be applied along the peripheral side edges and/or a center line of the reinforcing strips, but also can include other types of known hot melt adhesives, including rubber based, pressure sensitive adhesives, and/or amorphous polyolefin adhesives.

As shown in FIG. 1A, shortly after the hot melt adhesive 33 is applied to the reinforcing strips, the sheet of carton material 13 is fed from a supply 36 into an overlying relationship over the reinforcing strips 11 for lamination thereto. The carton material generally is formed from a paperboard material, such as what is used for the reinforcing material strips, or can include other types of natural and synthetic carton materials including cardboard, various plastic materials, etc. It will also be understood by those skilled in the art that while FIG. 1A illustrates one example embodiment of the present invention where the carton material is fed into an overlying relationship for attachment to the reinforcing strips to which the cold set and hot melt adhesives have been applied, it is also possible to apply the cold set and hot melt adhesives to the carton material, and thereafter bring the reinforcing strips into registration therewith.

As the carton material and reinforcing strips are brought into registration, they are passed through a laminating station 37, which generally includes one or more pairs of compression or nip rolls 38 and 39. The carton material and reinforcing strips are passed between the nip rolls, which engage and provide sufficient compression force to squeeze or compress the reinforcing strips and carton material together into adhesive contact. As a result, the hot melt adhesive will adhere the carton material and reinforcing strips together to form a laminated, reinforced carton material sheet that will resist de-lamination or separation during later, downstream cutting operations.

Thereafter, as shown in FIG. 1B, the laminated reinforced carton material sheet is then passed through a pulling unit or station 41 that includes a series of pivoting puller rolls 42 and 43. Each puller roller 42 and 43 is pivotable about arrows 44, 44′ and 46, 46′, respectively, for web tension control. As indicated in FIG. 1B, the cutting station 50 generally includes a platen die cutter, or similar cutting mechanism that stamps or die cuts a series of carton blanks 10 from the laminated reinforced carton material sheet as it is passed therethrough.

Accordingly, the present invention provides a method of producing carton blanks having desired enhanced temperature bonding properties as provided by cold set adhesive materials at increased production speeds, typically over approximately 100 feet per minute. The use of the limited, measured amount of hot melt adhesive helps reduce production costs, while enabling the formation and in-line cutting of the carton blanks from the laminated carton materials shortly after the lamination operation or step has been performed, as part of a substantially continuous single operation or process without requiring the significant delay or time lag required to allow the cold set adhesive material to cure. Instead, the carton blanks can be formed and then stacked and stored, during which time the cold set adhesive can cure. The resultant carton blanks will have a desired wide range of high/low temperature or thermal bonding properties to resist melting and delamination at high temperatures and brittleness and cracking of the sheets at very low or freezing temperatures generally provided with the use of such cold set adhesives, while still enabling greater production rates through the use of the hot melt adhesive in combination therewith.

It will be understood by those skilled in the art that while the present invention has been discussed above with respect to various preferred embodiments and/or features thereof, numerous changes, modifications, additions and deletions can be made thereto without departing from the spirit and scope of the invention as set forth in the following claims.

1. A method of applying a reinforcing material to a carton blank, comprising:
moving at least one strip of reinforcing material along a processing path;
applying a cold set adhesive to the at least one strip of reinforcing material;
applying a hot melt adhesive to the at least one strip of reinforcing material;
moving a carton material into registration with the at least one strip of reinforcing material; and
forming the carton blank from the carton material and strip of reinforcing material.

2. The method of claim 1 and wherein applying a hot melt adhesive comprises placing the hot melt adhesive adjacent at least one side edge of the at least one strip of reinforcing material.

3. The method of claim 2 and further comprising placing a line of hot melt adhesive along each side edge of the at least one strip of reinforcing material.

4. The method of claim 1 and wherein moving the carton material into registration with the at least one strip of reinforcing material comprises feeding a paperboard web into contact with the at least one strip of reinforcing material and urging the paperboard web and reinforcing material together to set the hot melt adhesive for holding the paperboard web and reinforcing material together.

5. The method of claim 4 and wherein urging the paperboard web and reinforcing material together comprises passing the paperboard web and reinforcing material through compression rollers.

6. The method of claim 1 and wherein forming the carton blank comprises die cutting the carton blank from the carton material with the at least one strip of reinforcing material adhered thereto.

7. The method of claim 1 wherein moving the at least one reinforced strip along a processing path comprises feeding a sheet of reinforcing material from a supply and cutting one or more strips of reinforcing material from the sheet of reinforcing material.

8. The method of claim 1 and wherein the carton blank is formed while the carton material and reinforcing material are held together by the hot melt adhesive, after which the cold set adhesive is cured.

9. A method of forming reinforced carton blanks, comprising:
moving a reinforcing material and a carton material along a processing path toward engagement with each other;
applying a cold set adhesive between the reinforcing material and the carton material;
applying a hot melt adhesive between the reinforcing material and the carton material;
adhering the reinforcing material and carton material together to form a laminated reinforced carton material sheet; and
forming the carton blanks from the laminated reinforced carton material as it continues along the processing path.

10. The method of claim 9 and wherein applying a hot melt adhesive comprises placing the hot melt adhesive adjacent at least one side edge of the at least one strip of reinforcing material.

11. The method of claim 9 and further comprising forming the reinforcing material into strips and applying the cold set and hot melt adhesives to the reinforcing strips.

12. The method of claim 11 and further comprising placing a line of hot melt adhesive along each side edge of the at least one strip of reinforcing material.

13. The method of claim 11 and wherein adhering the reinforcing material and the carton material comprises feeding a paperboard web into contact with the strips of reinforcing material strips, and urging the paperboard web and reinforcing material strips together to set the hot melt adhesive for holding the paperboard web and reinforcing material as the carton blanks are formed.

14. The method of claim 9 and wherein the carton blank is formed while the carton material and reinforcing material are held together by the hot melt adhesive, after which the cold set adhesive is cured.

15. A system for producing reinforced carton blanks, comprising:
a supply of reinforcing material strips fed along a processing path toward engagement with a carton material;
a cold set adhesive applicator station positioned along said processing path for applying a cold set adhesive between the reinforcing material strips and carton material;
a hot melt adhesive applicator station adjacent said cold set adhesive applicator station for applying a hot melt adhesive between the reinforcing material strips and the carton material;
a laminating station downstream from said hot melt adhesive applicator station and adapted to engage and urge the reinforcing material strips and carton material into contact so that the reinforcing material strips and carton material are held together by the hot melt adhesive to form a laminated material; and
a cutting station for forming the carton blanks from the laminated material.

16. the system of claim 15 and wherein said laminating station comprises a pair of compression rolls.

17. the system of claim 15 and wherein said cold set adhesive applicator station includes roll type applicators, spray applicators, or extrusion nozzles.

18. The system of claim 15 and wherein said hot melt adhesive applicator station includes roll type applicators, spray applicators, or extrusion nozzles.

19. The system of claim 15 and wherein said cutting station includes a die cutter.

20. The system of claim 15 and further comprising a cutting station positioned downstream from said supply of reinforcing material for cutting the reinforcing material into strips for attaching to the carton material.
